(19) United States
(12) Patent Application Publication
(10) Pub. No.: US 2023/0111956 A1
(43) Pub. Date: Apr. 13, 2023

(54) Measurement Device

(71) Applicant: Nippon Telegraph and Telephone Corporation, Tokyo (JP)

(72) Inventors: Yujiro Tanaka, Tokyo (JP); Daichi Matsunaga, Tokyo (JP)

(21) Appl. No.: 17/913,397

(22) PCT Filed: Apr. 1, 2020
(86) PCT No.: PCT/JP2020/015026

§ 371 Date: Sep. 21, 2022

(51) Int. Cl. G01K 17/08

(52) U.S. Cl. CPC G01K 17/08

(57) ABSTRACT

A measurement device includes: a sensor having a temperature sensor and a heat flux sensor; a first thermal rectification member that is disposed on a side of the sensor opposite from a side of the sensor configured to be in contact with a surface of a skin of a living body which is a measurement surface of a measurement target, and that is composed of a material having a higher thermal conductivity than air; and a structural member that is placed to be in contact with the measurement surface and that is spaced from the sensor and encloses the sensor.

### CROSS-REFERENCE TO RELATED APPLICATIONS

This application is a national phase entry of PCT Application No. PCT/JP2020/015026, filed on Apr. 1, 2020, which application is hereby incorporated herein by reference.

### TECHNICAL FIELD

The present invention relates to a measurement device for measuring a core body temperature of a living body.

### BACKGROUND

There has been known a technique for noninvasively measuring the core body temperature of a living body. For example, Patent Literature 1 discloses a technique for estimating the core body temperature of a living body by assuming a pseudo one-dimensional model including a living body, a sensor including a temperature sensor and a heat flux sensor, and outside air.

In the technique disclosed in Patent Literature 1, the core body temperature of a living body is estimated by using the following relational expression (1) based on a one-dimensional model of heat transfer of a living body.

core body temperature Tc=the temperature (Ts) of the point of contact between the temperature sensor and the skin+proportionality coefficient (α)×the heat (Hs) that flows into the temperature sensor (1)

The proportionality coefficient a is in general obtained by using a rectal temperature or an eardrum temperature measured with a sensor such as another temperature sensor as the core body temperature Tc.

However, for example, in the case of assuming a one-dimensional model as the heat transfer model of a living body as in the conventional technique described in Patent Literature 1, if there is a spatial distribution of heat flowing into or out of the sensor, the one-dimensional model as above no longer holds. The proportionality coefficient a in the above expression (1) varies during measurement, causing a large error in the estimation value of the core body temperature T_{c}. For this reason, conventional techniques for measuring core body temperatures sometimes do not provide enough measurement accuracy.

### CITATION LIST

### Patent Literature

Patent Literature 1: Japanese Patent Laid-Open No. 2020-003291.

### SUMMARY

### Technical Problem

Embodiments of the present invention have been made to solve the foregoing problem, and an object thereof is to provide a measurement device in which the spatial distribution of heat flowing into and out of the sensor is reduced.

### Means for Solving the Problem

To solve the foregoing problem, a measurement device according to embodiments of the present invention includes: a measurement unit having a temperature sensor and a heat flux sensor; a first member that is disposed on a side of the measurement unit opposite from a side of the measurement unit configured to be in contact with a measurement surface of a measurement target, and that is composed of a material having a higher thermal conductivity than air; and a structural member that is placed to be in contact with the measurement surface and that is spaced from the measurement unit and encloses the measurement unit.

### Effects of embodiments of the Invention

The measurement device according to embodiments of the present invention includes the first member that is disposed on the side of the measurement unit opposite from the side of the measurement unit configured to be in contact with the measurement surface of the measurement target, and that is composed of a material having a higher thermal conductivity than air, and the structural member that is placed to be in contact with the measurement surface and that is spaced from the measurement unit and encloses the measurement unit. Thus, it is possible to reduce the spatial distribution of heat flowing into or out of the sensor due to outside air.

### BRIEF DESCRIPTION OF THE DRAWINGS

FIG. 1 is a schematic diagram of a cross section of a measurement device according to a first embodiment of the present invention.

FIG. 2 is a diagram for explaining an overview of the present invention.

FIG. 3 is a block diagram illustrating an example of the configuration of the measurement device according to the first embodiment.

FIG. 4 is a schematic diagram of a cross section of a measurement device according to a specific example 1 of the first embodiment.

FIG. 5A is an outer-appearance perspective view of the measurement device according to the specific example 1.

FIG. 5B is a cross-sectional view of the measurement device according to the specific example 1.

FIG. 6 is a diagram for explaining an advantageous effect of the measurement device according to the first embodiment.

FIG. 7 is a schematic diagram of a cross section of a measurement device according to a specific example 2 of the first embodiment.

FIG. 8A is an outer-appearance perspective view of a measurement device according to a specific example 3 of the first embodiment.

FIG. 8B is a cross-sectional view of the measurement device according to the specific example 3.

FIG. 9A is an outer-appearance perspective view of a measurement device according to a specific example 4 of the first embodiment.

FIG. 9B is a cross-sectional view of the measurement device according to the specific example 4.

FIG. 10 is a schematic diagram of a cross section of a measurement device according to a second embodiment of the present invention.

FIG. 11 is a diagram for explaining an advantageous effect of the measurement device according to the second embodiment.

### DETAILED DESCRIPTION OF ILLUSTRATIVE EMBODIMENTS

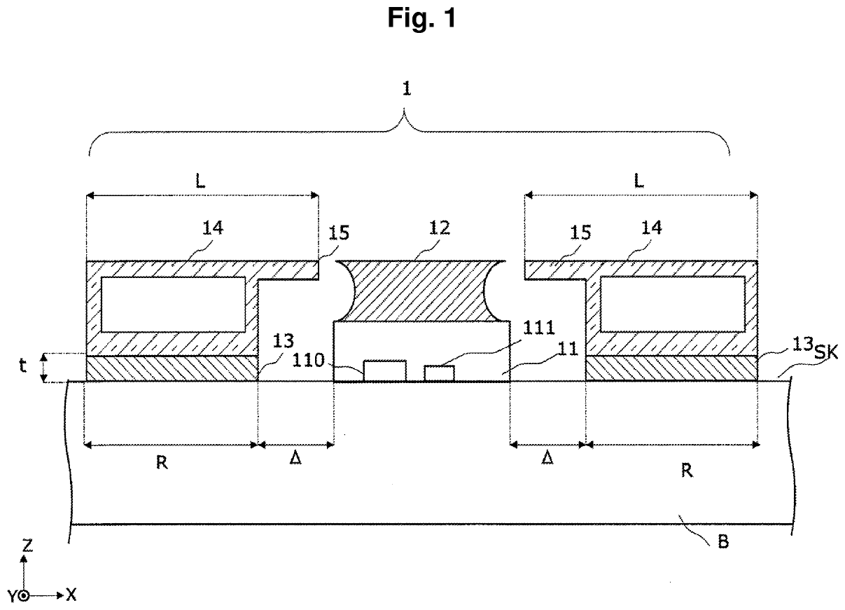

Hereinafter, preferred embodiments of the present invention will be described in detail with reference to FIGS. 1 to 11. Note that the following describes a case in which the “measurement surface” on which a measurement device is placed is the surface of a skin of a living body which is a measurement target.

### Overview of Embodiments of Invention

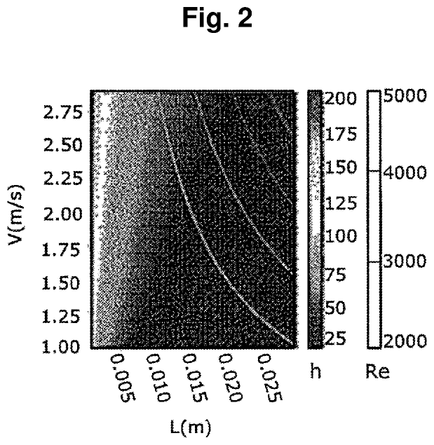

First, an overview of a measurement device according to embodiments of the present invention will be described with reference to FIG. 2. One of examples in which a spatial distribution occurs in inflow and outflow of heat in a heat transfer model of a living body including the living body, a sensor that is placed to be in contact with a skin of the living body and measures heat flux and temperature, and outside air is a case in which the model is affected by convection of the outside air. In addition to the convection of the outside air, the paths of blood vessels in the living body cause a slight spatial distribution.

First, effects of convection will be described. Convection is a phenomenon of convective heat transfer that removes heat from an object by the flow of air in the convection. The amount of heat removed from the object, specifically, the foregoing sensor by the convective heat transfer is determined by the thickness of the air in the region on the surface of the object, which is called a boundary layer, where air flow can be considered to be nearly stationary.

It is difficult to directly measure this boundary layer, but it is possible to obtain information on the thickness of the boundary layer by using the Nusselt number Nu which is a dimensionless number representing the ratio of the heat transfer coefficient h, which represents the degree of heat transfer when convection occurs, to the thermal conductivity λ of fluid (air). More specifically, the heat transfer coefficient h representing the degree of convective heat transfer when convection occurs is expressed by the Nusselt number Nu, the Reynolds number Re, and the Prandtl number Pr. It is known that the heat transfer coefficient h can be obtained on a plane as below.

Nu=h·L/λ (2)

Nu=0.664Re^{½}Pr^{⅓} (laminar flow) (3)

=0.037Re^{⅘}Pr^{⅓} (turbulent flow) (3)'

Re=ρVL/μ (4)

Pr=VC/λ (5)

In the above expressions (2) to (5), L represents the distance from the end face of the flat plate, λ the thermal conductivity of air, μ the viscosity of air, C thermal capacity of air, ρ the density of air, and V the flow speed.

By calculating the heat transfer coefficient h from these expressions (2) to (5), the heat transfer coefficient h according to the distance L and the flow speed V as illustrated in FIG. 2 is obtained. The depth of the gradation in FIG. 2 indicates the heat transfer coefficient h [W/m²K], and the curved lines in FIG. 2 indicate the points corresponding to Reynolds numbers of 2000, 3000, 4000, and 5000. The air flows with Reynolds numbers of up to approximately 3000 can be considered as laminar flows.

It can be seen that the heat transfer coefficient h changes according to the distance L from the end face of the sensor, indicated by the horizontal axis of FIG. 2. In addition, more heat is removed on the windward side which is indicated by the flow speed V on the vertical axis of FIG. 2, and the degree to which heat is removed sharply decreases toward the leeward side. This causes a large distribution of inflow and outflow of heat on the right and left sides of the sensor. As described earlier, the temperature distribution in the living body also causes the distribution of heat flowing into and out of the sensor.

A conceivable method to reduce such spatial distribution of heat in a simplest way is covering the entire sensor with a material having a high thermal conductivity such as metal, and even if a heat distribution occurs, diffusing the heat immediately. However, in this method, the difference between the temperature Ts at the point of contact between the sensor and the skin and the temperature of the upper portion of the sensor is small, which makes the amount of heat flowing into the sensor small. In other words, the amount of the heat (heat flux) Hs that flows into the sensor, which is used for estimation of the core body temperature, is small, and this degrades the sensitivity of the sensor greatly. For this reason, the measurement error in the core body temperature can be large. In addition, stricter sensitivities are required for the temperature sensor and the heat flux sensor composing the sensor.

The measurement devices according to the embodiments of the present invention have a structure to reduce effects of air flow by focusing attention on the thickness of the boundary layer of the air flow outside the sensor, in other words, a structure in which the external structure of the sensor makes the temperature distribution in the living body linear and a structure to reduce effects of change in the heat resistance outside the sensor even if the sensor receives convection from outside air.

### First Embodiment

Next, a measurement device 1 according to a first embodiment of the present invention will be described with reference to FIGS. 1 to 9B. Note that in each figure in the following description, the right-left or horizontal direction on the drawing plane is the X direction, the up-down direction or the vertical direction on the drawing plane is the Z direction, and the direction perpendicular to the drawing plane is the Y direction.

First, a principal part of the measurement device 1 will be described. FIG. 1 is a diagram schematically illustrating a cross section of the measurement device 1 placed to be in contact with a skin SK of a living body B. The measurement device 1 includes a sensor (measurement unit) 11, a first thermal rectification member (first member) 12, a second thermal rectification member (second member) 13, an enclosure member (third member) 14, and an eave 15.

The sensor 11 includes a heat flux sensor 110 and a temperature sensor 111. The heat flux sensor 110 and the temperature sensor 111 are housed, for example, inside a casing.

The heat flux sensor 110, which detects heat transfer per unit time per unit area, measures the heat flux Hs [W/m²] that flows into the sensor 11. For the heat flux sensor 110, for example, an actuation thermopile of a layered structure type or a planar expansion type or the like can be used.

The temperature sensor 111 measures the epidermis temperature Ts which is the temperature of the point of contact with the living body B. For the temperature sensor 111, for example, a thermistor, a thermocouple, a platinum resistor, an IC temperature sensor, or the like can be used.

The casing of the sensor 11 housing the heat flux sensor 110 and the temperature sensor 111 in its inside is, for example, circular in plan view and is formed of a member having a disk-like outer shape. The casing that the sensor 11 has, has a lower surface positioned to be in contact with a measurement surface of the skin SK (hereinafter referred to as “the lower surface of the sensor 11”) and an upper surface positioned in a direction away from the measurement surface of the skin SK (hereinafter referred to as “the upper surface of the sensor 11”). For example, the lower surface of the sensor 11 has an opening, and through this opening, the heat flux sensor 110 and the temperature sensor 111 are exposed.

The first thermal rectification member 12 is provided on the side opposite from the side configured to be in contact with the surface of the skin SK of the living body B which is the measurement surface of the measurement target, and the first thermal rectification member 12 is composed of a material having a higher thermal conductivity than air. To be more specific, the first thermal rectification member 12 is provided on the upper surface of the sensor 11, and relaxes the temperature distribution and the heat inflow distribution on the upper surface of the sensor 11 and also releases heat from the sensor 11. The first thermal rectification member 12, for example, covers the entire upper surface of the sensor 11 and has a thickness along the Z direction. For the material of the first thermal rectification member 12, a metal or the like having a relatively large thermal conductivity can be used.

For the first thermal rectification member 12, it is desirable from the viewpoint of the efficiency of heat rectification and heat release that the member have a larger surface area and also have a larger cross-sectional area so that the heat resistance value can be small. In the case in which the first thermal rectification member 12 is formed to have a larger size, the above effects become larger. However, on the other hand, the size and weight of the sensor 11 increase. The measurement device 1 is, for example, designed to have such a surface area and a weight that a light weight design and a small size suitable as a wearable device configured to be attached to the living body B can be achieved and that heat rectification and heat release in the sensor 11 can be sufficiently obtained. For example, as illustrated in FIG. 1, the first thermal rectification member 12 can have a structure in which its cross section is uniform along the Z direction and only the side surfaces have curvatures.

In the present embodiment, the sensor 11 and the first thermal rectification member 12 form an inner core structure of the measurement device 1. With this inner core structure, it is possible to promote heat transfer in the vertical direction (the Z direction).

The second thermal rectification member 13 and the enclosure member 14 are placed to be in contact with the measurement surface and form a g that is spaced from the sensor 11 and encloses the sensor 11.

The second thermal rectification member 13 is placed to be in contact with the measurement surface (on the XY plane) and composed of a material having a higher thermal conductivity than air. To be more specific, as illustrated in FIG. 1, the second thermal rectification member 13 is placed being spaced from the sensor 11 on the measurement surface (on the XY plane) of the skin SK of the living body B. The second thermal rectification member 13 is placed on the measurement surface, for example, so as to enclose the inner core structure composed of the sensor 11 and the first thermal rectification member 12 with such a distance A from the sensor 11 as not to be in contact with the sensor 11. The distance A of the measurement surface between the second thermal rectification member 13 and the sensor 11 forms a thermal gap between them.

The second thermal rectification member 13 is composed of a material having a relatively high thermal conductivity such as metal or the like and relaxes the distribution of heat flowing into and out of the living body B. For example, the width R along the measurement surface of the second thermal rectification member 13 can be approximately 3 [mm], and the thickness t along the Z direction can be 1 [mm].

Note that in the case in which the sensor 11 has a casing having a disk-like outer shape, and the radius of the lower surface is larger than or equal to at least approximately 10 [mm], which is relatively large, the second thermal rectification member 13 can be composed of a material having a relatively low thermal conductivity such as a polymer.

The enclosure member 14 is disposed on the second thermal rectification member 13 and encloses the sensor 11. The enclosure member 14 has a lower surface and an upper surface, and the width along the measurement surface of the lower surface agrees with the width R of the second thermal rectification member 13.

The eave 15 extends from the enclosure member 14 in the direction toward the first thermal rectification member 12. The eave 15 is formed of the same material as the enclosure member 14 integrally with the enclosure member 14.

As illustrated in FIG. 1, the length L of the upper surface of the enclosure member 14 and eave 15 is a preset length along the measurement surface. The enclosure member 14 and the eave 15 are placed to enclose the sensor 11 together with the second thermal rectification member 13 on the measurement surface, and the enclosure member 14, the eave 15, and the second thermal rectification member 13 form an outer peripheral ring structure that encloses the inner core structure composed of the sensor 11 and the first thermal rectification member 12.

In the present embodiment, the distance Δ between the outer peripheral ring structure (structural member) composed of the second thermal rectification member 13, the enclosure member 14, and the eave 15 and the sensor 11 and the second thermal rectification member 13 forms a thermal gap, and the thermal gap reduces heat transfer in the horizontal direction (measurement surface direction), in other words, the temperature gradient.

As illustrated in FIG. 1, the upper surface of the enclosure member 14 and eave 15 and the upper surface of the first thermal rectification member 12 have approximately the same height in the Z direction and are placed apart from each other in such a degree as not to be in contact with each other. It is desirable that the boundary layer continue without air flow not separating between the enclosure member 14 and eave 15 and the first thermal rectification member 12.

As described with reference to FIG. 2, the heat transfer coefficient h is largest at the end face of the object, specifically, the end face of the enclosure member 14 and the eave 15, and as the following expression (6) indicates, the heat transfer coefficient h decreases sharply in proportion to L^{-⅔} from the end face of the enclosure member 14.

(in the case of a laminar flow)

h=λ/L·Nu=λ/L·0.664Re^{½}Pr^{⅓}∝L^{-⅔} (6)

Thus, for example, on the assumption of convection in everyday life, the length L along the X direction (measurement surface) of the enclosure member 14 and eave 15 should be larger than or equal to 2 [mm]. In the case of forming irregularities on the surface of the enclosure member 14 and eave 15, the irregularities disturb the air flow field, making it possible to expand the growth of the boundary layer caused by the convection due to the sensor 11 and outside air.

The enclosure member 14 may have a hollow structure to be lighter. The material of the enclosure member 14 may be a polymer or the like. For example, the enclosure member 14 and the eave 15 can be made by using a 3D printer or the like.

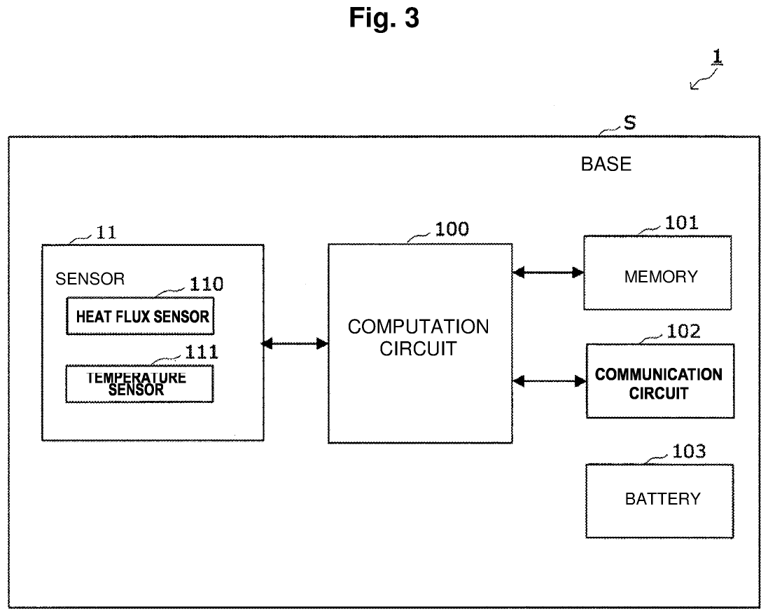

Note that in the case in which the inner core structure formed of the sensor 11 and the first thermal rectification member 12 and the outer peripheral ring structure (structural member) formed of the second thermal rectification member 13, the enclosure member 14, and the eave 15 are completely spaced from each other as illustrated in the example of FIG. 1, the relative positions of those are kept by a not-illustrated connection structure. For example, the distance Δ between the sensor 11 and the second thermal rectification member 13 is kept by using a sheet-shaped base S (FIG. 3) that is placed on the surface of the skin SK or by using another connection structure.

[Configuration of Measurement Device]

Next, the overall configuration of the measurement device 1 according to the present embodiment will be described with reference to FIG. 3

As illustrated in FIG. 3, the measurement device 1 includes the principal part of the measurement device 1 described with reference to FIG. 1, a computation circuit 100, a memory 101, a communication circuit 102, and a battery 103. Note that in FIG. 3, the first thermal rectification member 12, the second thermal rectification member 13, the enclosure member 14, and the eave 15 are omitted.

The measurement device 1 includes, on the sheet-shaped base S, the sensor 11, the computation circuit 100, the memory 101, the communication circuit 102 that functions as an I/F circuit with the outside, and the battery 103 that supplies electric power to the computation circuit 100, the communication circuit 102, and the like.

The computation circuit 100 calculates an estimation value of the core body temperature Tc from the heat flux Hs and the epidermis temperature Ts of the skin SK measured by the sensor 11 by using the foregoing expression (1). The computation circuit 100 may generate and output time series data of estimated core body temperatures Tc of the living body B. The time series data means data including measurement time and estimated core body temperatures Tc associated with each other.

The memory 101 stores information on a one-dimensional heat transfer model of a living body based on the foregoing expression (1). The memory 101 also stores the heat resistance value of the heat flux sensor 110. The memory 101 can be a specified storage area of a rewritable nonvolatile storage device (for example, a flash memory or the like) provided in the measurement system.

The communication circuit 102 outputs time series data of the core body temperature Tc of the living body B generated by the computation circuit 100, to the outside. In the case of outputting data in a wired way, the communication circuit 102 as above is an output circuit to which a USB cable or other types of cables can be connected, but it may be a wireless communication circuit, for example, conforming to Bluetooth (registered trademark), Bluetooth Low Energy, or the like.

The sheet-shaped base S not only functions as a base on which the measurement device 1 is placed including the sensor 11, the computation circuit 100, the memory 101, the communication circuit 102, and the battery 103 but also includes not-illustrated wiring for electrically connecting these elements. Considering that the measurement device 1 is connected to epidermis of a living body, it is desirable that a deformable flexible substrate be used for the sheet-shaped base S.

Part of the sheet-shaped base S has an opening, and the heat flux sensor 110 and the temperature sensor 111 included in the sensor 11 are placed on the base S so as to be in contact with the measurement surface of the skin SK of the living body B through the opening.

Here, the measurement device 1 is configured by including a computer. Specifically, the computation circuit 100 is implemented, for example, by a processor such as a CPU or a DSP executing various kinds of data processing according to programs stored in the storage device such as a ROM, a RAM, or a flash memory, including the memory 101 provided in the measurement device 1. The above programs for causing the computer to function as the measurement device 1 can be recorded on a recording medium or can be supplied through a network.

Note that although in the measurement device 1 in FIG. 3, the principal part including the sensor 11 described with reference to FIG. 1 and other constituents including the computation circuit 100 are configured as one unit, the principal part of the measurement device 1 may be separate from the computation circuit 100, the memory 101, the communication circuit 102, and the battery 103.

### SPECIFIC EXAMPLE 1

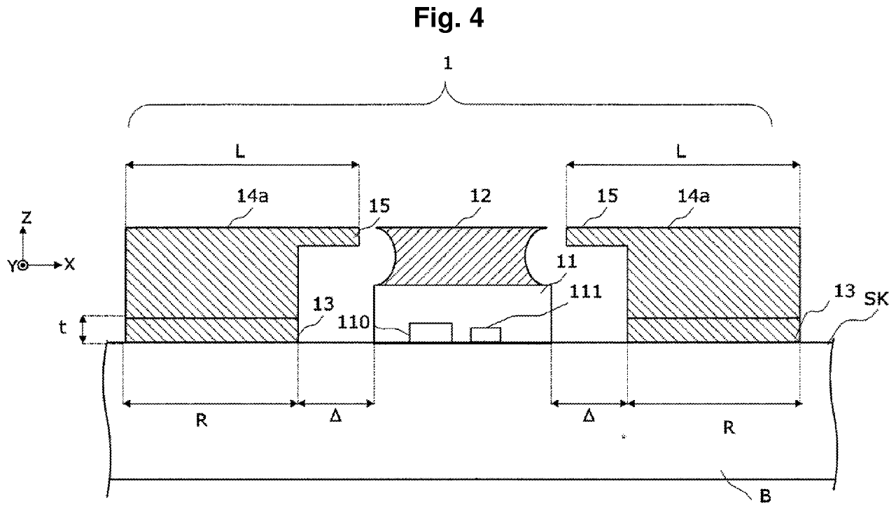

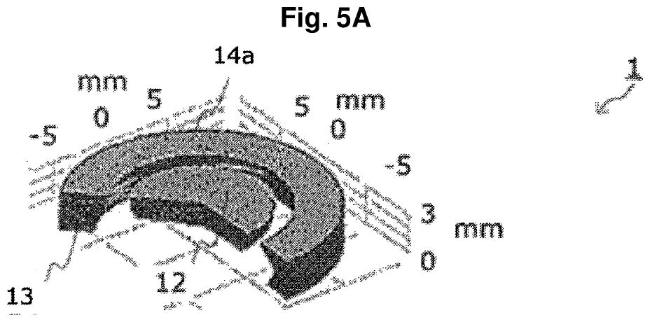

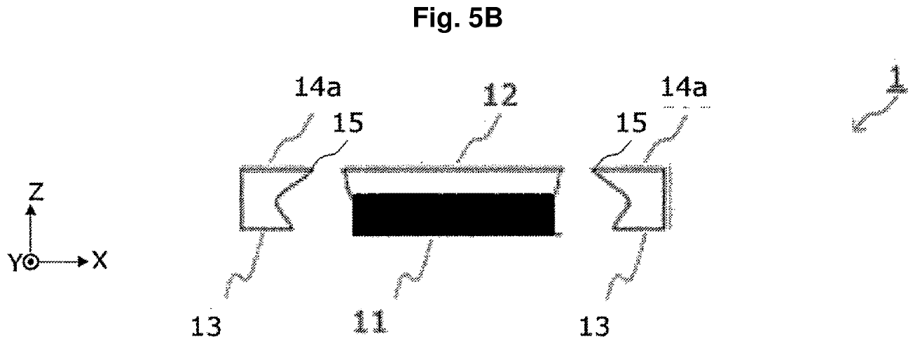

Next, a specific example 1 of the measurement device 1 having the foregoing functions and configurations will be described with reference to FIGS. 4 to 5B.

FIG. 4 is a diagram schematically illustrating a cross section of a measurement device 1 according to the specific example 1. The measurement device 1 includes a sensor 11, a first thermal rectification member 12, a second thermal rectification member 13, an enclosure member 14a, and an eave 15.

The enclosure member 14a and the eave 15 included in the measurement device 1 according to the specific example 1 have shapes the same as or similar to those of the enclosure member 14 and the eave 15 described earlier and are formed of the same material as the second thermal rectification member 13 integrally with the second thermal rectification member 13. The enclosure member 14a, the eave 15, and the second thermal rectification member 13 are formed of a material having a relatively high thermal conductivity such as metal.

FIG. 5A is a diagram illustrating an outer-appearance perspective view and a cross section of the measurement device 1 according to the specific example 1. FIG. 5B is a cross-sectional view of the measurement device 1 in FIG. 5A.

As illustrated in FIG. 5A, the measurement device 1 includes the sensor 11 and first thermal rectification member 12 having a disk shape, an annular second thermal rectification member 13 enclosing the sensor 11 and the first thermal rectification member 12 with a constant distance A around them, and the enclosure member 14a and eave 15. For example, the second thermal rectification member 13, the enclosure member 14a, and the eave 15 can be made by cutting aluminum into a torus-like structure. The first thermal rectification member 12 has a structure in which aluminum is cut into a columnar shape, and the resultant member is attached immediately above the sensor 11 that measures temperature and heat flux.

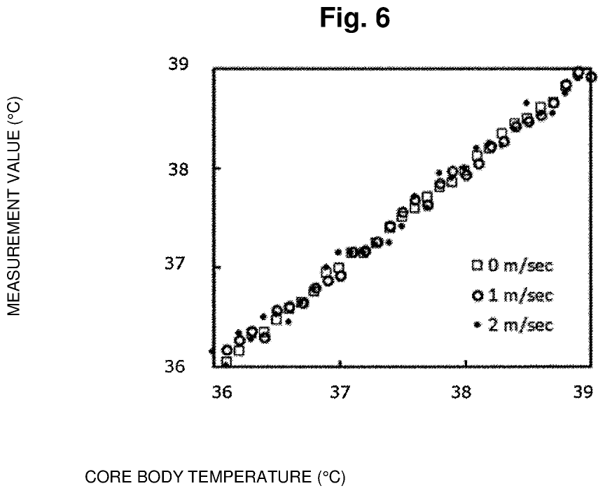

FIG. 6 shows measurement results of the core body temperature measured by using the measurement device 1 according to the specific example 1 illustrated in FIGS. 5A and 5B. In FIG. 6, the horizontal axis represents the core body temperature [° C.], and the vertical axis represents the measurement value [° C]. The three different marks in FIG. 6 represent the air speeds in respective measurement environments, in other words, convection. It can be seen from FIG. 6 that the measurement device 1 can measure core body temperatures without being affected by the convection.

### SPECIFIC EXAMPLE 2

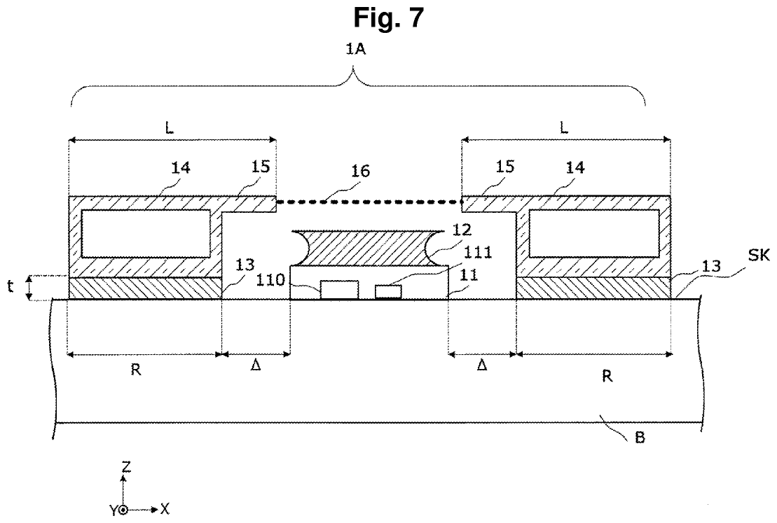

Next, another specific example 2 of the measurement device 1 according to the present embodiment will be described with reference to FIG. 7. FIG. 7 is a diagram schematically illustrating a partial cross section of a measurement device 1A according to the specific example 2. The measurement device 1A according to the specific example 2 is different from the measurement device 1 according to the first embodiment in that it further includes a lattice 16.

The lattice 16 has a porous structure and is formed between the end portions of the upper surface of the enclosure member 14 and eave 15 so as to cover the upper surface of the first thermal rectification member 12. The lattice 16 may be formed of, for example, the same material as the enclosure member 14 and the eave 15, such as a polymer. The porous structure may be a sheet-shaped mesh or the like. The lattice 16 placed to cover the upper surface of the first thermal rectification member 12 reduces interference in heat transfer above the first thermal rectification member 12.

### SPECIFIC EXAMPLE 3

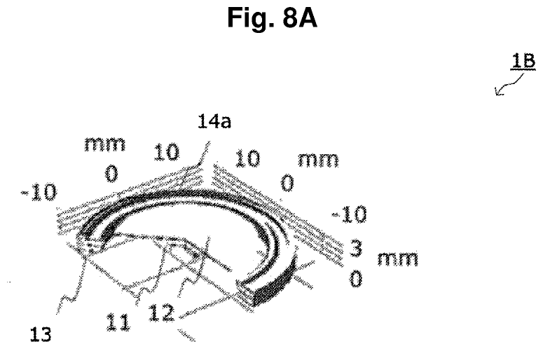

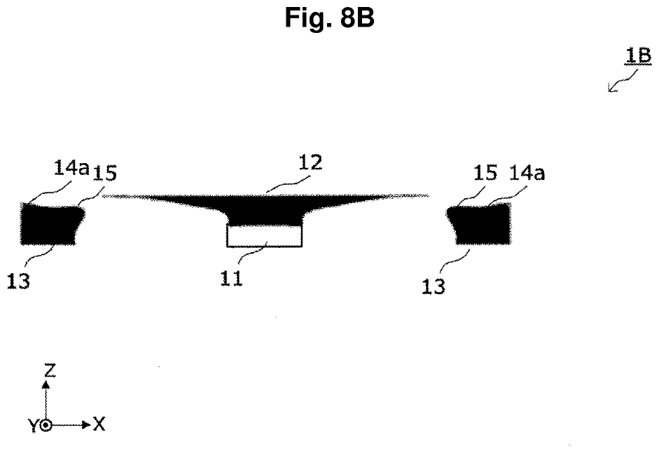

Next, another specific example 3 of the measurement device 1 according to the present embodiment will be described with reference to FIGS. 8A and 8B. FIG. 8A is a diagram illustrating an outer-appearance perspective view and a cross section of a measurement device 1B according to the specific example 3. FIG. 8B is a cross-sectional view of the measurement device 1B illustrated in FIG. 8A.

As illustrated in FIGS. 8A and 8B, the diameter along the measurement surface of the upper surface of a first thermal rectification member 12 is larger than the diameter along the measurement surface of the upper surface of a sensor 11, and thus, the surface area of the first thermal rectification member 12 can be large. In this case, the length of an eave 15 extending in the direction toward the first thermal rectification member 12 can be smaller than the length explained in the first embodiment. The first thermal rectification member 12 having the structure illustrated in FIGS. 8A and 8B can relax the temperature distribution and the heat inflow distribution on the upper surface of the sensor 11 and also can more efficiently release heat from the sensor 11.

### SPECIFIC EXAMPLE 4

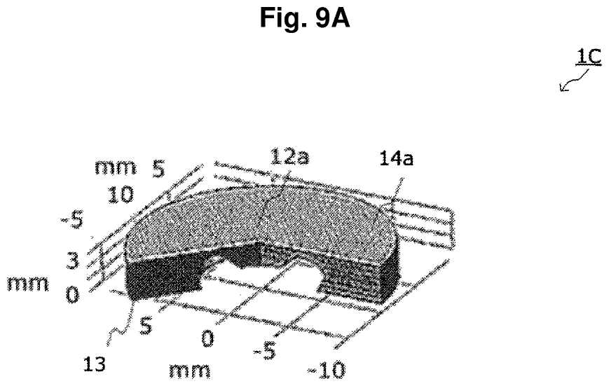

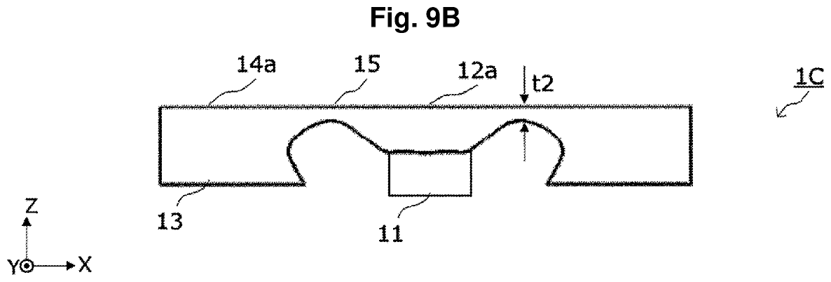

Next, another specific example 4 of the measurement device 1 according to the present embodiment will be described with reference to FIGS. 9A and 9B. FIG. 9A is a diagram illustrating an outer-appearance perspective view and a cross section of a measurement device 1C according to the specific example 4. Note that in FIG. 9A, illustration of the sensor 11 is omitted.

As illustrated in FIGS. 9A and 9B, a second thermal rectification member 13, an enclosure member 14a, and an eave 15 of the measurement device 1C are formed integrally, and the eave 15 is connected to a first thermal rectification member 12a. For example, the second thermal rectification member 13, enclosure member 14a, and eave 15 and the first thermal rectification member 12a can be formed of a material having a high thermal conductivity such as aluminum.

As illustrated in FIG. 9B, the thickness t2 along the Z direction of the eave 15 is formed to be smaller than the thickness of the first thermal rectification member 12a. As described above, since the second thermal rectification member 13, the enclosure member 14a, the eave 15, and the first thermal rectification member 12a are formed integrally, those can be formed of the same material.

### Advantageous Effects of First Embodiment

As has been described above, the measurement device 1 according to the first embodiment includes the first thermal rectification member 12 disposed on the upper surface of the sensor 11, the second thermal rectification member 13 provided along the measurement surface so as to be spaced from the sensor 11, the enclosure member 14 disposed on the upper surface of the second thermal rectification member 13, and the eave 15 extending from the enclosure member 14 in the direction toward the first thermal rectification member 12. Thus, it is possible to reduce a spatial distribution of heat flowing into or out of the sensor 11. This makes it possible to measure the core body temperature of a living body noninvasively with higher accuracy.

### Second Embodiment

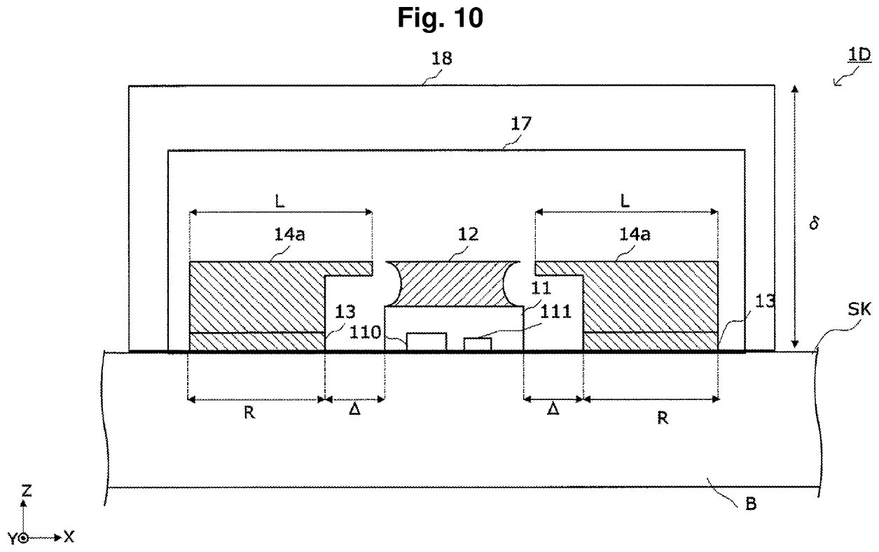

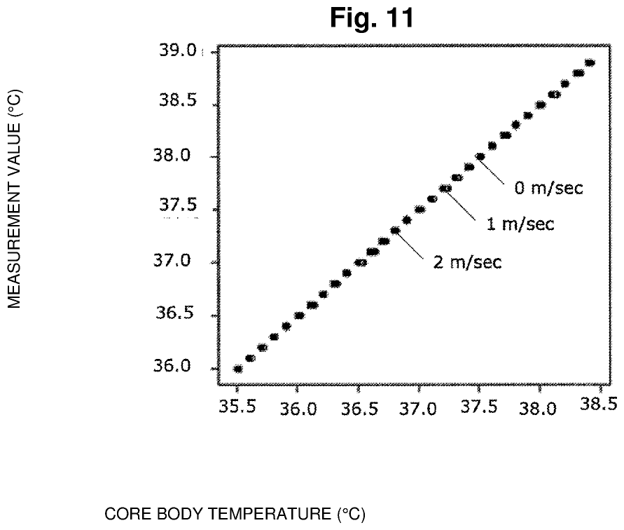

Next, a second embodiment of the present invention will be described with reference to FIGS. 10 and 11. Note that in the following description, the same constituents as in the foregoing first embodiment are denoted by the same signs, and description thereof is omitted.

The measurement device 1 according to the first embodiment has a structure in which the upper surface of the first thermal rectification member 12 and the upper surface of the enclosure member 14 and eave 15 are in direct contact with outside air. In contrast, a measurement device 1D according to the second embodiment further includes a plurality of covers 17 and 18.

FIG. 10 is a diagram schematically illustrating a cross section of the measurement device 1D according to the present embodiment. Note that the configurations other than the covers 17 and i8 included in the measurement device 1D are the same as or similar to those described in the specific example 1 of the first embodiment (FIGS. 4, 5A, and 5B).

Here, there is known the Biot number Bi as a dimensionless number expressing the ratio of the heat transfer from the surface of a solid and the heat conduction inside the solid. The Biot number Bi, which is expressed by the following expression (7), is used as an index of the stability of heat transfer.

Bi=hL/λ (7)

Note that λ represents the thermal conductivity, h the heat transfer coefficient, and L the thickness of a living body.

As is well known, in the case in which the Biot number Bi is sufficiently smaller than 1, the heat conduction inside the solid is faster than the heat transfer. Thus, the temperature distribution inside the object can be considered to be approximately uniform. For example, in the case in which the Biot number Bi is approximately 0.1, the approximation by the one-dimensional living-body heat transfer model described with reference to the foregoing expression (1) can be used. In the case in which the Biot number Bi is approximately 0.1, the heat transfer coefficient h of the water included in the living body B is h<approximately 6 [W/m²K], the heat transfer coefficient h of muscle is h<approximately 4 [W/m²K], and the heat transfer coefficient h of fat is h<approximately 1.8 [W/m²K]. Thus, in the case in which the Biot number Bi in the above expression (7)<<0.1, the foregoing expression (6) shows that it is necessary to control the thickness of the boundary layer to create a state in which air around the measurement device 1D does not move, and there is nearly no air flow.

Hence, in the measurement device 1D according to the present embodiment, for example, as illustrated in FIG. 10, the covers 17 and 18 having two hollow structures cover the first thermal rectification member 12, the second thermal rectification member 13, the enclosure member 14a, and the eave 15 placed around the sensor 11. For example, the covers 17 and 18 are formed of thin film such as PET film, and the thickness of the film can be, for example, 100 [μm].

Between the cover 17 and the sensor 11, the first thermal rectification member 12, the second thermal rectification member 13, the enclosure member 14a, and the eave 15 provided inside the cover 17 is formed an air layer. In addition, the measurement device 1D include another cover 18 outside the cover 17, and an air layer is also formed between the inner cover 17 and the outer cover 18.

A small room of the air layer is formed by the cover 17, and an air layer is formed between the cover 17 and the cover 18 outside the cover 17. Thus, there are provided small rooms for air partitioned so that the air inside each of the covers 17 and 18 cannot move. As illustrated in FIG. 10, the thickness δ in the Z direction of the air layer which is the boundary layer formed by the cover 18 can be, for example, about 6 [mm] or more.

FIG. 11 is a diagram showing measurement values of core body temperatures measured by using the measurement device 1D according to the present embodiment. In FIG. 11, the vertical axis represents the measurement value (° C.), and the horizontal axis represents the true value of the core body temperature (° C.). Each mark represents an outside air speed, in other words, convection. FIG. 11 shows that, with the measurement device 1D having the small rooms formed by the covers 17 and 18 in which air does not move, it is possible to measure the core body temperature of the living body more accurately even if outside air flow comes in contact with the measurement device 1D.

As has been described above, since the measurement device 1D according to the second embodiment has small rooms for air partitioned by the plurality of covers 17 and 18, it is possible to reduce the influence of change in the heat resistance of the outside of the sensor 11 even if air flow comes in contact with the measurement device 1D. This makes it possible to measure the core body temperature of a living body noninvasively with higher accuracy.

Although the embodiments of the measurement device of the present invention have been described above, the present invention is not limited to the described embodiments, but various modifications that those skilled in the art conceive can be made within the scope of the invention described in the claims.

### REFERENCE SIGNS LIST

1 Measurement Device

11 Sensor

12 First Thermal Rectification Member

13 Second Thermal Rectification Member

14 Enclosure Member

15 Eave

S Base

110 Heat Flux Sensor

111 Temperature Sensor

100 Computation Circuit

101 Memory

102 Communication Circuit

103 Battery.

1.-8. (canceled)

9. A measurement device comprising:
a measurement circuit having a temperature sensor and a heat flux sensor;
a first member disposed on a first side of the measurement circuit, the first side of the measurement circuit being opposite from a second side of the measurement circuit configured to be in contact with a measurement surface of a measurement target, and the first member being composed of a material having a higher thermal conductivity than air; and
a structural member configured to be in contact with the measurement surface and that is spaced from the measurement circuit and encloses the measurement circuit.

10. The measurement device according to claim 9, wherein the measurement circuit and the first member are circular in plan view, and the structural member is annular in plan view.

11. The measurement device according to claim 9, wherein the structural member further includes:
a second member configured to be in contact with the measurement surface and composed of a material having a higher thermal conductivity than air;
a third member disposed on the second member; and
the third member has an eave extending in a direction toward the first member.

12. The measurement device according to claim 11, wherein
the eave is connected to the first member.

13. The measurement device according to claim 11, wherein
the second member and the third member are integrally formed of a same material.

14. The measurement device according to claim 13, wherein
the eave is connected to the first member.

15. The measurement device according to claim 9, wherein a height of the structural member from the measurement surface matches with a height of the first member from the measurement surface.

16. The measurement device according to claim 9, further comprising:
a first cover that has a hollow structure and covers the measurement circuit, the first member, and the structural member; and
a second cover that has a hollow structure and covers the first cover to define an air layer between the first cover and the second cover.

17. A measurement device comprising:
a measurement circuit having a temperature sensor and a heat flux sensor;
a first member disposed on a first side of the measurement circuit, the first side of the measurement circuit being opposite from a second side of the measurement circuit configured to be in contact with a measurement surface of a measurement target, and the first member being composed of a material having a higher thermal conductivity than air;
a structural member configured to be in contact with the measurement surface and that is spaced from the measurement circuit and encloses the measurement circuit;
a memory configured to store a one-dimensional model of heat transfer of a living body; and
a computation circuit configured to estimate a core temperature of the living body using heat flux and temperature measured by the measurement circuit based on the one-dimensional model stored in the memory.

18. The measurement device according to claim 17, wherein the measurement circuit and the first member are circular in plan view, and the structural member is annular in plan view.

19. The measurement device according to claim 17, wherein the structural member further includes:
a second member configured to be in contact with the measurement surface and composed of a material having a higher thermal conductivity than air;
a third member disposed on the second member; and
the third member has an eave extending in a direction toward the first member.

20. The measurement device according to claim 19, wherein
the eave is connected to the first member.

21. The measurement device according to claim 19, wherein
the second member and the third member are integrally formed of a same material.

22. The measurement device according to claim 21, wherein
the eave is connected to the first member.

23. The measurement device according to claim 17, wherein a height of the structural member from the measurement surface matches with a height of the first member from the measurement surface.

24. The measurement device according to claim 17, further comprising:
a first cover that has a hollow structure and covers the measurement circuit, the first member, and the structural member; and
a second cover that has a hollow structure and covers the first cover to define an air layer between the first cover and the second cover.
